(19) United States
(12) Patent Application Publication
(10) Pub. No.: US 2025/0060392 A1
(43) Pub. Date: Feb. 20, 2025

(54) PLURALITY OF MEMS FOR INCREASED BANDWIDTH

(71) Applicant: InvenSense, Inc., San Jose, CA (US)

(72) Inventors: Matthew Julian Thompson, Beaverton, OR (US); Joseph Seeger, Menlo Park, CA (US); Gavin Ho, Mountain View, CA (US)

(21) Appl. No.: 18/498,198

(22) Filed: Oct. 31, 2023

Related U.S. Application Data
(60) Provisional application No. 63/532,741, filed on Aug. 15, 2023.

(51) Int. Cl. G01P 15/08

(52) U.S. Cl. CPC G01P 15/08

(57) ABSTRACT

A MEMS device incorporates a first sensor and a second sensor to receive an external excitation and respectively output signals to processing circuitry. The processing circuitry combines the first and second signals to create a third signal, which includes an output from the first sensor when the external excitation is between a first and second frequency relatively close to DC and an output from the second sensor when the external excitation is between a third and fourth frequency at a higher frequency range.

### CROSS REFERENCE TO RELATED APPLICATION

This application claims priority to U.S. Provisional Patent Application No. 63/532,741, entitled “DUAL MEMS FOR INCREASED BANDWIDTH” and filed on Aug. 15, 2023, which is incorporated by reference herein in its entirety.

### BACKGROUND

Numerous items such as smart phones, smart watches, tablets, automobiles, aerial drones, appliances, aircraft, exercise aids, and game controllers may utilize microelectromechanical system (MEMS) sensors during their operation. Inertial sensors (e.g., accelerometers and gyroscopes) may be analyzed independently or together to determine information for particular applications. For example, gyroscopes and accelerometers may be used in gaming applications (e.g., smart phones or game controllers) to capture complex movements by a user, drones and other aircraft may determine orientation based on measured parameters (e.g., roll, pitch, and yaw), and vehicles may utilize inertial sensor measurements for determining direction (e.g., for dead reckoning) and safety (e.g., to recognizing skid or roll-over conditions).

MEMS sensors may be fabricated using semiconductor manufacturing techniques. In some implementations, a MEMS sensor includes movable proof masses that move in response to external forces such as linear acceleration (e.g., for MEMS accelerometers), angular velocity (e.g., for MEMS gyroscopes), barometric pressure, sound pressure, a magnetic field, etc. A sensing element measures the movement of the movable proof mass caused by the external force, for example, based on a capacitor formed between a reference electrode and the movable proof mass. Depending on the sensor design, a MEMS sensor may have different response characteristics at different frequencies where sensing is more accurate or stable.

### SUMMARY

In an embodiment of the present disclosure, a MEMS device comprises a first sensor configured to output a first signal and a second sensor configured to output a second signal, wherein the first and the second sensors are configured to receive an external excitation to generate the first and the second signals, respectively. The MEMS device further comprises processing circuitry that receives a signal based on the first signal and a signal based on the second signal and outputs a third signal in response to the external excitation, wherein the third signal includes the first signal within a first frequency range between a first frequency and a second frequency, and wherein the third signal includes the second signal in a second frequency range between a third frequency and a fourth frequency, wherein the first frequency is less than the second, the third, and the fourth frequencies, and wherein the fourth frequency is greater than the first, the second, and the third frequencies.

In an embodiment of the present disclosure, a MEMS device comprises a first sensor configured to output a first signal based upon a movement of a first proof mass of the first sensor relative to a first sensing element having a first voltage and a variable first charge and a second sensor configured to output a second signal based upon a movement of a second proof mass the second sensor relative to a second sensing element. The second signal is based upon a variable voltage signal provided to the second sensing element, and the first and the second sensors are configured to receive an external excitation to generate the first and the second signals, respectively. The MEMS device comprises processing circuitry configured to receive the first signal and the variable voltage signal, wherein the processing circuitry is configured to generate a third signal, wherein the third signal includes a portion of the first signal between a first frequency and a second frequency, and wherein the third signal includes a portion of the variable voltage signal between a third frequency and a fourth frequency.

In an embodiment of the present disclosure, a method comprises receiving an external excitation at a MEMS device comprising a first sensor and a second sensor, wherein the first sensor is configured to output a first signal in response to the external excitation, and wherein the second sensor is configured to output a second signal in response to the external excitation. The method further comprises generating a third signal from a signal based on the first signal and a signal based on the second signal, wherein the third signal includes the first signal when the external excitation is between a first frequency and a second frequency, and wherein the third signal includes the second signal when the external excitation is between a third frequency and a fourth frequency.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative MEMS system in accordance with an embodiment of the present disclosure;

FIG. 2 shows an illustrative MEMS accelerometer in accordance with an embodiment of the present disclosure;

FIG. 3 shows an illustrative one-sided MEMS accelerometer in accordance with an embodiment of the present disclosure;

FIG. 4A shows an illustrative one-sided MEMS accelerometer in accordance with an embodiment of the present disclosure;

FIG. 4B shows an illustrative one-sided MEMS accelerometer translated in accordance with an embodiment of the present disclosure;

FIG. 5A shows an illustrative circuit diagram of a combined MEMS system in accordance with an embodiment of the present disclosure;

FIG. 5B shows an illustrative circuit diagram of an additional embodiment of a combined MEMS system in accordance with an embodiment of the present disclosure;

FIG. 6 shows an illustrative diagram depicting respective operational bandwidths of a first sensor and a second sensor in accordance with an embodiment of the present disclosure;

FIG. 7 shows an illustrative diagram depicting an operational bandwidth of a combined MEMS system in accordance with an embodiment of the present disclosure; and

FIG. 8 shows an illustrative flowchart for combining a plurality of MEMS output signals into a combined signal in accordance with an embodiment of the present disclosure.

### DETAILED DESCRIPTION

An inertial MEMS sensor such as an accelerometer may utilize a sensor design that has a relatively low bandwidth while prioritizing a response having stable offset and sensitivity within a relatively low bandwidth at a low frequency. These sensors typically use charge sensing circuits to convert the mechanical motion of the proof mass to a variable charge. Higher bandwidth MEMS sensors, like microphones, may use a constant charge circuit where a feedback circuit converts the mechanical motion of the proof mass to a variable voltage. In some embodiments, a constant charge design may be utilized with an additional accelerometer, which may optimize the second accelerometer to provide an output signal that has a high bandwidth at higher frequencies. Other accelerometer designs may include “one-sided” accelerometers in which the capacitive output is not sensed differentially, and that generally have an accurate and stable output response within a higher frequency range than typical differential sensing accelerometer designs. When the output signals of multiple accelerometers having different frequency responses are combined (e.g., along with additional processing such as low-pass, band-pass, and/or high-pass filters) the combined output signal may provide a stable and accurate output over a large frequency range, e.g., including both low frequency components (e.g., linear acceleration due to movement of a device) and higher-frequency and bandwidth components (e.g., bone conduction sensing).

In an embodiment of the present disclosure, a MEMS device may have a plurality of sensors (e.g., accelerometers), that are optimized for performance across different frequency ranges associated with an external excitation. For example, a first sensor may be optimized for performance in a first frequency range, while a second sensor is optimized for performance in a second frequency range different from the first frequency range. The first sensor may generally be optimized for performance in a lower frequency range and may be relatively more stable at low frequencies as compared with a second sensor. Additional sensors may, by comparison, be optimized for performance in a different frequency ranges (e.g., a higher frequency range) than the first sensor, for example, based on the sensor design and including a constant charge sensing circuit design. The respective output signals from the sensors are processed by processing circuitry such as a low-pass filter associated with the first sensor and high-pass or band-pass filters associated with each additional sensor, such that a combined output signal includes only the signal frequency components where the respective sensors are optimized for sensing. The resulting signals are combined and scaled (e.g., by digital processing circuitry after analog-to-digital conversion), resulting in a combined signal that includes stable and accurate sensing over a frequency range from DC to the higher frequencies associated with the additional sensors.

In at least some examples, the sensors are accelerometers that are configured in different manners, resulting in the relative output response differences depending on frequency of a received external excitation. For example, accelerometers or sensors may have a proof mass that is supported differently within the device, resulting in a tendency for better performance in different frequency ranges. Merely as examples, one sensor may have a proof mass that pivots out-of-plane both towards and away from corresponding sense electrodes for differential sensing, which in an embodiment, may provide high stability and accuracy at frequency ranges close to DC. A second sensor may have a proof mass that has a relatively unstable design at low frequencies (e.g., a single-sided out-of-plane accelerometer or a suspended plunge-type accelerometer) but provides accurate and stable sensing over a bandwidth at higher frequencies.

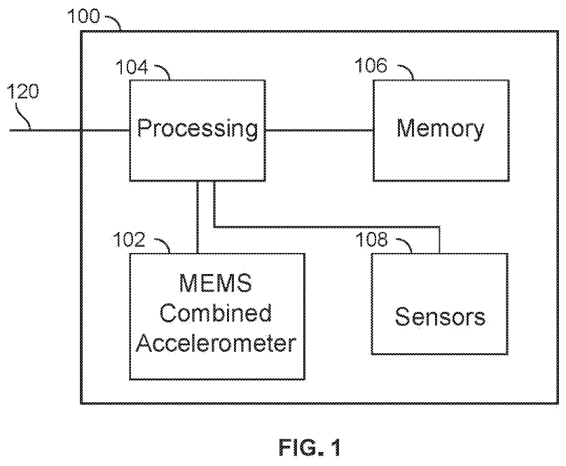

FIG. 1 shows an illustrative MEMS system 100 in accordance with an embodiment of the present disclosure. Although particular components are depicted in FIG. 1, it will be understood that other suitable combinations of the MEMS, processing components, memory, and other circuitry may be utilized as necessary for different applications and systems. In at least some embodiments, the circuitry, devices, systems, and methods described herein are described in the context of a system including processing circuitry configured to operate a combined MEMS system. More specifically, in at least some examples, the MEMS system is configured to receive external excitations (e.g., an injected signal, a linear acceleration, an angular velocity, a change in air pressure, a magnetic field, sound pressure, etc.) at combined MEMS sensors (e.g., each having independently moving proof masses), each of which outputs a respective output signal to processing analog and digital circuitry. In this example, a first sensor outputs a first signal at a first frequency range between a first and second frequency, in response to the external excitation in the first frequency range, and the second sensor outputs a second signal at a second frequency range between a third and fourth frequency, in response to the external excitation in the second frequency range, to generate a combined, third signal that includes the first signal (e.g., when the external excitation or portions thereof are between the first and second frequency) and the second signal (e.g., when the external excitation or portions thereof are between the third and fourth frequency). It will be understood that the circuitry, devices, systems, and methods described herein may be applied to other types of MEMS devices or sensors.

Processing circuitry 104 may include one or more components providing processing based on the requirements of the MEMS system 100. In some embodiments, processing circuitry 104 may include hardware control logic that may be integrated within a chip of a sensor (e.g., on a base substrate of a MEMS combined accelerometer 102 or other sensor 108, or on an adjacent portion of a chip to the MEMS combined accelerometer 102 or other sensor 108) to control the operation of the MEMS combined accelerometer 102 or other sensors 108 and perform aspects of processing for the MEMS combined accelerometer 102 or the other sensors 108. In some embodiments, the MEMS combined accelerometer 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the MEMS combined accelerometer 102 by interacting with the hardware control logic and processing signals received from MEMS combined accelerometer 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”). In some embodiments, rather than a MEMS combined accelerometer 102 as described herein, the MEMS sensor may be a different sensor type such as a gyroscope, a barometer, a pressure sensor, a microphone, or a magnetometer, etc.

Although in some embodiments (not depicted in FIG. 1), the MEMS combined accelerometer 102 or other sensors 108 may communicate directly with external circuitry (e.g., via a serial bus or direct connection to sensor outputs and control inputs), in an embodiment the processing circuitry 104 may process data received from the MEMS combined accelerometer 102 and other sensors 108 and communicate with external components via a communication interface 110 (e.g., a serial peripheral interface (SPI) or I2C bus, in automotive applications a controller area network (CAN) or Local Interconnect Network (LIN) bus, or in other applications a suitably wired or wireless communications interface as is known in the art). The processing circuitry 104 may convert signals received from the MEMS combined accelerometer 102 and other sensors 108 into appropriate measurement units (e.g., based on settings provided by other computing units communicating over the communication interface 110) and perform more complex processing to determine measurements such as orientation or Euler angles, and in some embodiments, to determine from sensor data whether a particular activity (e.g., speaking, gesturing, walking, running, braking, skidding, rolling, etc.) is taking place. In some embodiments, some or all of the conversions or calculations may take place on the hardware control logic or other on-chip processing of the MEMS combined accelerometer 102 or other sensors 108.

In some embodiments, certain types of information may be determined based on data from multiple MEMS combined accelerometers 102 and other sensors 108 in a process that may be referred to as sensor fusion. By combining information from a variety of sensors it may be possible to accurately determine information that is useful in a variety of applications, such as image stabilization, navigation systems, automotive controls and safety, dead reckoning, remote control and gaming devices, activity sensors, 3-dimensional cameras, industrial automation, and numerous other applications.

In accordance with the present disclosure, a combined MEMS device includes a first sensor (e.g., an accelerometer having a first design and sensing architecture), which, in response to an external excitation, outputs a stable first signal in a first frequency range between a first and second frequency closer to DC, and one or more additional sensors (e.g., a second accelerometer having a second design and sensing architecture), which output stable additional signals in additional, higher frequency ranges (e.g., a second frequency range between a third and fourth frequency associated with the second accelerometer) in response to the external excitation (e.g., including multiple excitations such as a linear acceleration due to motion within the first frequency range and linear acceleration due to bone conduction within the second frequency range). The MEMS device may be configured to output a combined (e.g., third) signal by combining a portion of the first signal from the first sensor in the first frequency range with the additional signals (e.g., the second signal from the second sensor in the second frequency range), such that the third (combined) signal has an accurate and stable output within both the first frequency range and additional frequency ranges.

For example, the first sensor is configured to rotate about or move along an axis for differential sensing with respect to complementary sensing electrodes, and by design has a relatively low bandwidth. Such an exemplary differential sensing design improves sensor linearity but lowers the operating frequency range, based on both sides of the proof mass rotating in response to the external excitation (e.g., linear acceleration, a Coriolis force, air pressure, sound pressure, a magnetic field, etc.). Accordingly, the first sensor inherently functions at a lower frequency and is designed to have stable offset and sensitivity at low frequency external excitations and is therefore stable for external DC excitations. The first sensor utilizes a sensing element (e.g., differential capacitors formed by the proof mass and sense electrodes) that outputs a variable charge signal that changes in response to the movement of the proof mass due to the external excitation. In some embodiments, the variable charge signal is generated based on a constant voltage applied to the sensing element. In some embodiments, the first sensor may move in-plane (e.g., translate within a MEMS layer) and/or out-of-plane (e.g., move perpendicular to the MEMS layer). In some embodiments, the external excitation is a linear acceleration, and the first and second sensors are accelerometers. In some embodiments, in response to an external excitation that is air pressure, sound pressure, a magnetic field, or a Coriolis force, each of the first and second sensor may be a corresponding barometer, microphone, magnetometer, or gyroscope.

An exemplary second sensor operates in a high bandwidth and the proof mass is designed to translate with high stability within a bandwidth at a higher frequency range (e.g., a single sided sensor or suspended plunge-type sensor). The second sensor utilizes a sensing element such as a single-sided sensing element (e.g., a capacitor formed between the proof mass and a sense electrode). In some embodiments, the second sensor is configured to output a variable voltage in response to the external excitation by detecting changes in capacitance generated by the displacement of the second sensor relative to the sensing element (e.g., forming a moving capacitor). A feedback system provides a variable voltage to the sensing element by forcing a fixed charge on the sensing element. The sensing element may be a variable capacitor formed between the proof mass and a reference sense electrode (e.g., the single proof mass sense electrode) such that a voltage drop across the sensing element and the second sensor constantly changes to keep the charge applied to the second sensor constant, for example, based on an output of an amplifier that receives the capacitor sense signal. In some embodiments, the second accelerometer is a single-sided MEMS sensor in which, rather than a feedback path to retain a constant charge, the output of the second sensor is a variable charge that changes based on the movement of a proof mass in response to the external excitation. In this embodiment, the input voltage can be DC or may be an AC input for frequency upshifting of the sensing signal.

In some embodiments, in response to an input voltage greater than a threshold voltage, the second sensor may increase sensitivity (e.g., lower an effective spring rate of the second sensor) and broaden its operational bandwidth. In some embodiments, a spring softening associated with the proof mass is greater than 80% of the mechanical spring stiffness (e.g., the non-linearity of capacitance). In some embodiments, the second sensor, in response to the external excitation, outputs a second signal at a second frequency range between a third and fourth frequency that defines an audio frequency range (e.g., below 20 kHz or below 3.5 kHz). In some embodiments, the second sensor may move in-plane (e.g., translate within a MEMS layer) and/or out-of-plane (e.g., rotate towards or away from a substrate layer) with respect to a single sensing element.

An exemplary combined MEMS device further includes a processing circuitry (e.g., a first analog-to-digital converter (ADC), a second ADC, combining circuitry, and other processing circuitry such as filters and gain-offset-scaling circuitry (GOS))) that receives, at the first ADC, the first signal at the first frequency range and receives, at the second ADC, the second signal at the second frequency range. The first and second ADCs convert the first and second signals from the analog domain to the digital domain and respectively deliver the digital signals to the combining circuitry, which combines the selected digital input from the first ADC at the first frequency range (e.g., between a first frequency and a second frequency) and the selected digital input from the second ADC at the second frequency range (e.g., between a third frequency and a fourth frequency). In some embodiments, filtering and other processing of the signals may be performed in the analog domain (e.g., before the ADCs) or digital domain (e.g., after the ADCs) to emphasize and/or scale the portions of the first and second signals associated with the first and second frequency ranges. Although the signals may also be combined in the analog domain, processing circuitry such as combining circuitry (e.g., adders, multipliers, etc.) combines the digital signals to a single output line in the form of a third signal (e.g., a digital output signal), with scaling of the signals as appropriate to match the signal amplitudes. In some embodiments, the first sensor, the second sensor, and the signal processor (e.g., combination circuitry) may be located on a common substrate (e.g., CMOS, die, etc.). In some embodiments, the third signal may be scaled according to either time or amplitude to reduce its signal-to-noise ratio.

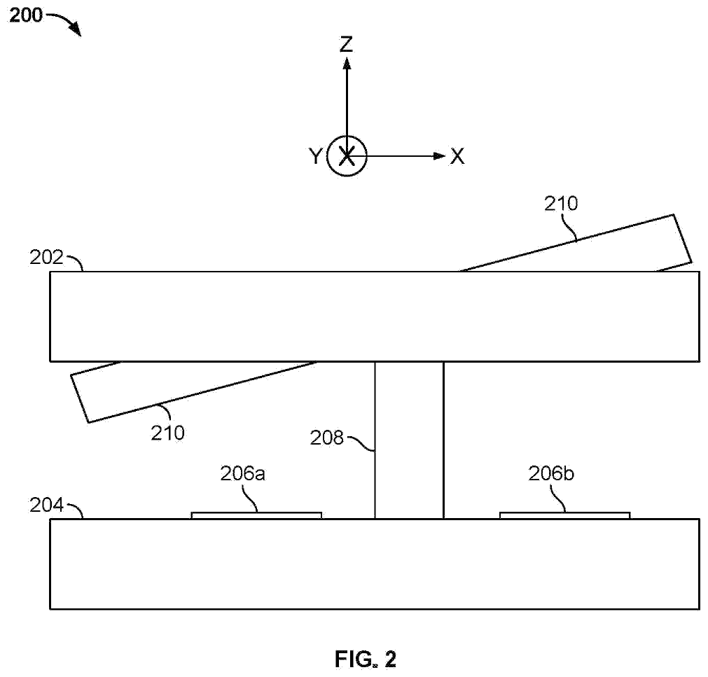

FIG. 2 shows an illustrative MEMS accelerometer 200 in accordance with an embodiment of the present disclosure. In an example, the MEMS accelerometer 200 may be employed as one accelerometer of the combined MEMS accelerometers 102 described above in FIG. 1. The exemplary MEMS accelerometer 200 of FIG. 2 is simplified for the purposes of illustration. A MEMS accelerometer, as described in the present disclosure, may include any suitable MEMS accelerometer design, including a single-axis or multi-axis MEMS accelerometer. Although portions of the present disclosure may be described in the context of a particular type of MEMS accelerometer configuration (e.g., a single-axis out-of-plane sensing accelerometer), the present disclosure may apply equally to other types and configurations of MEMS sensors or devices. Merely by way of example, the concepts herein may be applied in the context of a gyroscope or other MEMS device or a differential in-plane sensing accelerometer.

As illustrated in FIG. 2, the MEMS accelerometer 200 may include MEMS layer 202, substrate layer 204 (e.g., a complementary metal-oxide-semiconductor (CMOS) substrate layer coupled to an ASIC), and anchor 208 connecting between the layers (e.g., MEMS layer 202 and substrate layer 204) and located within and defining a gap between the two layers. Packaging and additional layers (e.g., a cap layer) are not shown in FIG. 2 for ease of illustration but may be coupled to the MEMS layer 202 and/or substrate layer 204 to form a hermetically sealed cavity in which the movable MEMS components of a suspended spring-mass system (e.g., including proof mass 210 and additional springs and/or masses coupled thereto—not depicted) are able to move. The cavity may have a nominal pressure (e.g., at or near atmospheric pressure, or another suitable pressure for other particular designs). In the exemplary embodiment of FIG. 2, a bottom plane of the suspended spring-mass system of the MEMS layer 202 is located parallel to an upper plane of the substrate layer 204 where proof mass sense electrodes 206a, 206b are located thereon, whereas in an in-plane embodiment the sense electrodes would be located in plane on opposite sides of the proof mass to respond to a x-axis or y-axis movement of the proof mass (e.g., via anchors or posts from the substrate and/or cap).

In the exemplary embodiment of FIG. 2, the proof mass is designed to move along the direction of the z-axis in response to the measured external excitation. For example, the illustrative MEMS accelerometer 200 includes a suspended spring-mass system including movable proof mass 210 and springs (not visible), where the springs are selectively patterned and positioned such that they are relatively rigid in response to forces in directions in which it is not desired to measure the external excitation.

Proof mass 210 is suspended over proof mass sense electrodes 206a, 206b. In response to a z-axis movement of the proof mass 210 due to, e.g., a linear acceleration experienced by MEMS accelerometer 200, the proof mass 210 is rotatable such that it rotates out of the plane of the MEMS layer 202 (e.g., about the y axis) such that portions of the proof mass 210 move closer to or farther away from respective proof mass sense electrodes 206a, 206b, with a degree of rotation (e.g., how much the proof mass 210 moves with respect to the respective proof mass sense electrodes 206a, 206b) based on the magnitude of the linear acceleration. The design of the suspended spring-mass system may be such that the proof mass 210 has minimal movement out of the MEMS plane in the absence of linear acceleration about the sense axis.

In the exemplary embodiment of FIG. 2, the movement of the proof mass 210 out of the MEMS plane may be sensed using differential electrostatic sensing as depicted in FIG. 2. Fixed proof mass sense electrodes 206a, 206b are located parallel to the proof mass 210 (e.g., on an upper plane of substrate layer 204 below proof mass 210) to form capacitors with portions of the proof mass 210 (e.g., electrode 206a forms a capacitor with a first portion of proof mass 210 and electrode 206b forms a capacitor with a second portion of proof mass 210). The capacitance of the proof mass 210 may change based on the relative distance between each proof mass 210 portion and its associated proof mass sense electrode. In the embodiment of FIG. 2, these capacitances are used by processing circuitry (e.g., located in the substrate layer 204) to determine the external excitation (e.g., linear acceleration). An exemplary differential sensing accelerometer such as that depicted in FIG. 2 may provide for stable sensing within a frequency range close to DC.

Although electrostatic sensing is described in the embodiment of FIG. 2, other forms of sensing (e.g., piezoelectric, infrared, or magnetic) may be used in other embodiments. While some or all of the processing circuitry may be described as located within the substrate layer 204 (e.g., a CMOS substrate layer), in some embodiments, a substrate may not include active processing components and may instead simply perform functions such as routing signals to other processing circuitry (e.g., on adjacent components to the MEMS accelerometer 200 and/or stacked on layers above or below the substrate layer 204, or cap layer, of the MEMS accelerometer 200).

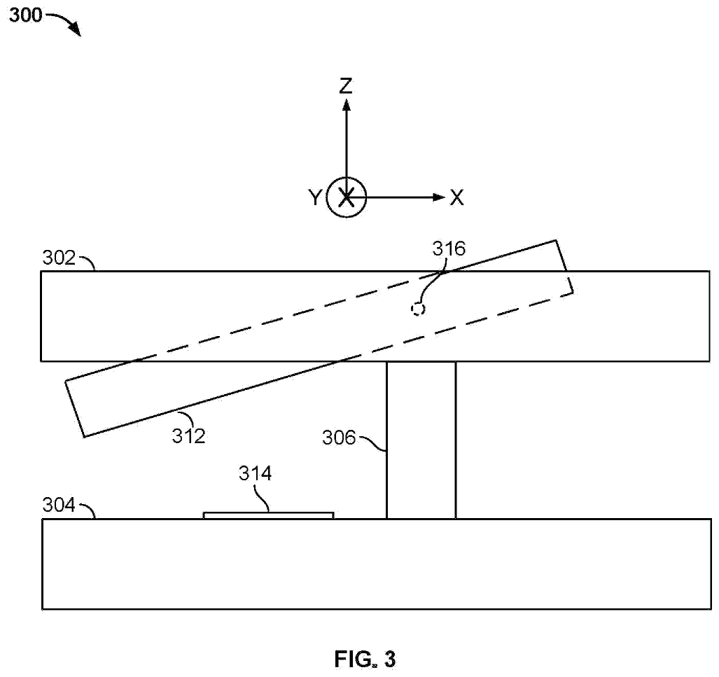

FIG. 3 shows an illustrative one-sided MEMS accelerometer 300 in accordance with an embodiment of the present disclosure. In an example, the MEMS accelerometer 300 may be employed as an additional sensor as described herein. The exemplary MEMS accelerometer 300 of FIG. 3 is simplified for the purpose of illustration. Although particular portions of the present disclosure may be described in the context of a particular type of MEMS accelerometer configuration (e.g., a single-axis out-of-plane sensing accelerometer), the present disclosure may apply equally to other types and configurations of MEMS sensors, including one-sided (e.g., not differential) in plane sensing (e.g., based on springs configured to be rigid in response to an out-of-plane force and/or perpendicular in-plane force).

As illustrated in FIG. 3, the MEMS accelerometer 300 may include MEMS layer 302, substrate layer 304 (e.g., a CMOS substrate layer), and anchor 306 separating the layers (e.g., MEMS layer 302 and substrate layer 304) and located within and defining a gap between the two layers. Packaging and additional layers (e.g., a cap layer) are not shown in FIG. 3 for ease of illustration but may be coupled to the MEMS layer 302 and/or substrate layer 304 to form a hermetically sealed cavity in which the movable MEMS components of a suspended spring-mass system including proof mass 312 (e.g., a one-sided proof mass) and additional springs and/or masses coupled thereto (not depicted) are able to move. The cavity may have a nominal pressure (e.g., at or near an atmospheric pressure, or another suitable pressure for other particular designs). In the exemplary embodiment of FIG. 3, a bottom plane of the suspended spring-mass system of the MEMS layer 302 is located parallel to an upper plane of the substrate layer 304 where proof mass sense electrode 314 is located thereon, whereas in an in-plane embodiment the sense electrode would be located in plane to respond to an x-axis or y-axis movement of the proof mass (e.g., via an anchor or post from the substrate and/or cap).

In the exemplary embodiment of FIG. 3, proof mass 312 is designed to move along the direction of the z-axis in response to the measured external excitation (e.g., a linear acceleration). For example, the illustrative MEMS accelerometer 300 includes a suspended spring-mass system including movable proof mass 312 and springs (not visible), where the springs are selectively patterned and positioned such that they are relatively rigid in response to forces in directions in which it is not desired to measure the external excitation.

Proof mass 312 is suspended over proof mass sense electrode 314. In response to a z-axis movement of the proof mass 312 (e.g., a one-sided proof mass) due to an external excitation (e.g., a z-axis linear acceleration) experienced by MEMS accelerometer 300, the proof mass 312 rotates out of the plane of the MEMS layer 302 (e.g., about the y-axis) such that proof mass 312 moves either towards or away from proof mass sense electrode 314 with a degree of movement (e.g., how much the proof mass 312 moves with respect to the proof mass sense electrode 314) based on the magnitude of the external excitation. The design of the suspended spring-mass system may be such that the proof mass 312 has minimal movement out of the MEMS plane in the absence of an external excitation about the sense axis. MEMS accelerometer 300 utilizes one-sided sensing where proof mass 312 rotates, with respect to proof mass sense electrode 314, about a pivot point 316 disposed or positioned at or near the end of the proof mass 312 in response to, e.g., an external excitation. As opposed to proof mass 210 of FIG. 2, proof mass 312 has a lower moment of inertia (e.g., due to less mass of the proof mass 312 being positioned on the opposite side of the pivot point 316 that moves in the opposite direction and also generally has less overall mass), which results in proof mass 312 being relatively more sensitive at higher frequencies. However, the single-sided sensing is more susceptible to non-ideal exogenous stresses like temperature, surface mounting, and board bending, making it less stable for DC loads than differential sensing.

In the exemplary embodiment of FIG. 3, the movement of the proof mass 312 out of the MEMS plane may be sensed using electrostatic sensing as depicted in FIG. 3. Proof mass sense electrode 314 is located parallel to the proof mass 312 (e.g., on an upper plane of substrate layer 304 below proof mass 312) to form a capacitor with proof mass 312. The capacitance of the proof mass 312 may change based on the relative distance between proof mass 312 and proof mass sense electrode 314, which change in charge may be used to determine the response to the external excitation. In an exemplary constant charge sensing architecture, the charge may be maintained at a fixed value via feedback circuitry. As described herein, the sensing of the movement of proof mass 312 may be performed using a charge sensing or a constant charge configuration. In some embodiments, in response to an input voltage greater than a threshold voltage, the proof mass 312 may increase in sensitivity (e.g., lowering the effective spring rate) and broaden operational bandwidth. In some embodiments a spring softening is greater than 80% of the mechanical spring stiffness. An example of such sensing circuitry is described and depicted in U.S. patent application Ser. No. 16/460,901, filed Jul. 2, 2019, entitled Applying a Positive Feedback Voltage to an Electromechanical Sensor Utilizing a Voltage-to-Voltage Converter to Facilitate a Reduction of Charge Flow in Such Sensor Representing Spring Softening, and U.S. Provisional Patent Application No. 62/718,954, Filed on Aug. 14, 2019, both of which are incorporated by reference in their entirety.

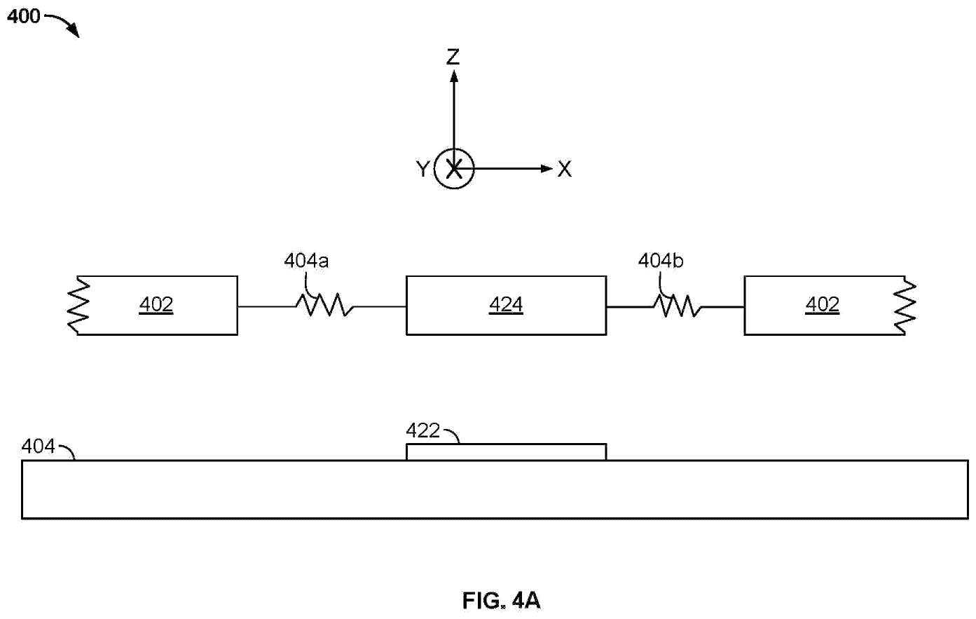

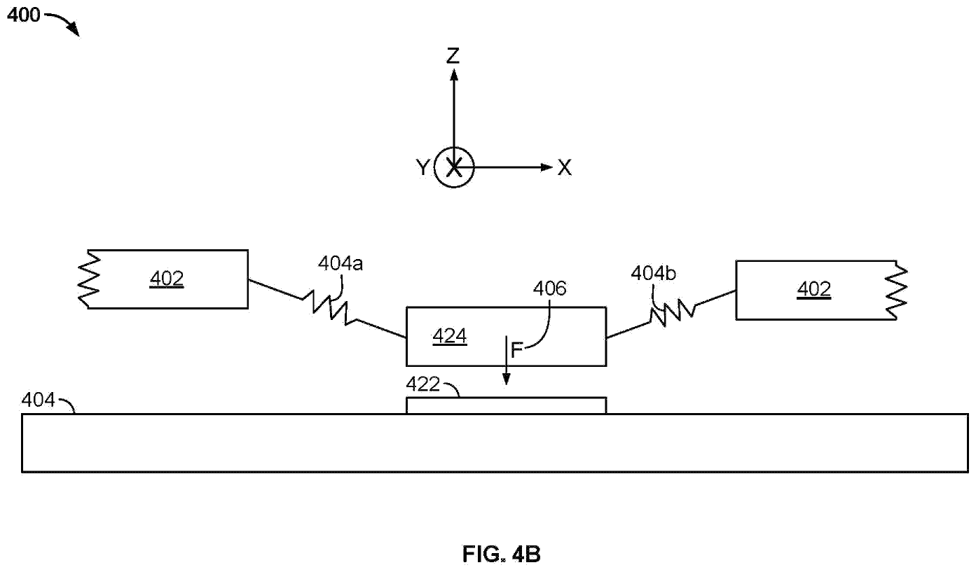

FIG. 4A shows an illustrative one-sided plunge-type MEMS accelerometer 400 in accordance with an embodiment of the present disclosure, while FIG. 4B shows an illustrative one-sided plunge-type MEMS accelerometer 400 moving in response to a z-axis linear acceleration in accordance with an embodiment of the present disclosure. In the depicted embodiment, MEMS accelerometer 400 includes MEMS layer 402 and substrate layer 404 (e.g., a CMOS substrate layer), proof mass 424 (e.g., a one-sided proof mass) and sensing element 422 (e.g., a sense electrode), springs 404a, 404b, and external excitation 406 (e.g., a z-axis linear acceleration). The exemplary MEMS accelerometer 400 of FIG. 4A is simplified for the purpose of illustration. MEMS accelerometer 400, as described in the present disclosure, may include any suitable MEMS accelerometer design, including single-axis or multi-axis MEMS accelerometers. Although particular components are depicted in certain configurations for MEMS accelerometer 400, components may be removed, modified, or substituted and additional components (e.g., electrodes, layers, processing circuitry, etc.) may be added in certain embodiments. For example, in an embodiment of an in-plane plunge-type MEMS accelerometer, the springs may be configured to allow the proof mass to plunge in the x-axis or y-axis direction, with a single-sided sense electrode in plane (e.g., via an anchor or post from the substrate and/or cap).

Proof mass 424, as illustrated in FIGS. 4A and 4B, may be configured to translate along the z-axis in response to an external excitation to a position shown by 406 (e.g., a linear acceleration). Springs 404a, 404b, which couple proof mass 424 to MEMS layer 402, are selectively patterned and positioned such that they are relatively rigid in response to forces in directions in which it is not desired to impart a drive motion (e.g., along the x-axis or along the y-axis of the MEMS layer) and relatively flexible in a direction in which a force is to be imparted or measured (e.g., along the z-axis normal to the MEMS layer). In some embodiments, any number of springs may couple proof mass 424 to MEMS layer 402. Proof mass 424 (e.g., a one-sided proof mass) is suspended, via springs 404a, 404b, over sensing element 422 (e.g., a proof mass sense electrode). In response to a z-axis movement of the proof mass 424 due to external excitation 406 experienced by MEMS accelerometer 400, the proof mass 424 either translates towards (e.g., in the negative z-axis direction) or away from (e.g., in the positive z-axis direction) sensing element 422 with a degree of displacement based on the magnitude of the external excitation 406. Proof mass 424 capacitively engages with sensing element 422 when translating with respect to sensing element 422 (e.g., forming a moving capacitor).

As described herein, the sensing architecture for the capacitor formed between proof mass 424 and sensing element 422 may be based on a change in charge or may be a constant charge architecture. Moreover, the design of the accelerometer of FIGS. 4A-4B may be such that the accelerometer is relatively stable within a frequency range that is generally a higher frequency range (e.g., an audible frequency range suitable for sensing speech via bone conduction) but is more susceptible to exogenous forces that can arise from temperature, surface mounting, board bending, etc. In some embodiments, in response to an input voltage greater than a threshold voltage, the proof mass 424 may increase in sensitivity (e.g., lower an effective spring rate of the proof mass 424) and broaden its operational bandwidth. In some embodiments, a spring softening is greater than 80% of the mechanical spring stiffness.

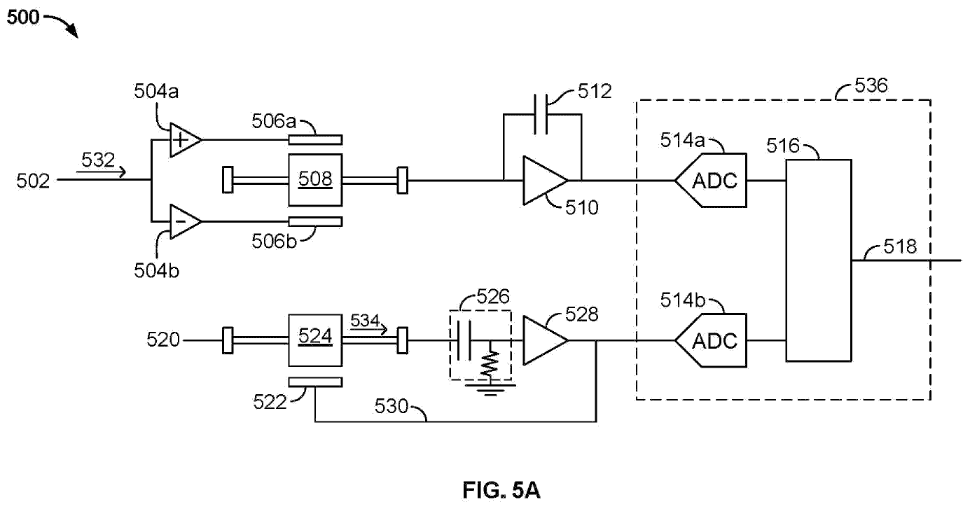

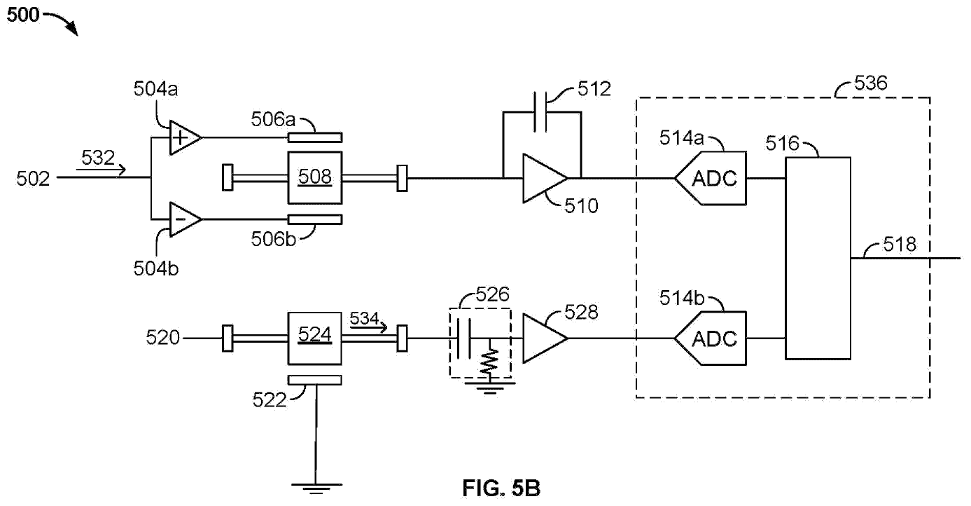

FIG. 5A shows an illustrative circuit diagram of a combined MEMS system (e.g., dual MEMS system 500) in accordance with an embodiment of the present disclosure. In the depicted embodiment, system 500 includes first voltage source 502 (e.g., providing an AC modulated voltage signal), signal 532, positive drive 504a (e.g., plus sensing), negative drive 504b (e.g., minus sensing), sensing elements 506a, 506b (e.g., including proof mass sense electrodes 206a, 206b), first sensor 508 (e.g., including proof mass 210), amplifier 510 (e.g., a low impedance amplifier), and feedback capacitor 512. System 500 further includes a DC voltage 520, second sensor 524 (e.g., including a second proof mass such as proof mass 312 or 424), sensing element 522 (e.g., including a single proof mass sense electrode such as sense electrode 314 or 422), constant charge output 534, variable voltage feedback signal 530, high-pass filter 526, amplifier 528 (e.g., a low impedance amplifier), and processing circuitry 536. The processing circuitry 536, in the example illustrated, further includes analog-to-digital converters (ADCs) 514a, 514b, combining circuitry 516, combined signal output 518, and other circuitry not depicted therein, such as additional filters, GOS circuitry, and the like. In another embodiment the combining circuitry can further include demodulators, amplitude modulators and other trimming circuitry that modifies and combines the two signals together. Furthermore, additional sensors designed to be stable within additional frequency ranges, and associated processing circuitry, may be included for additional applications of combined sensing. Although particular components are depicted in certain configurations for system 500, components may be removed, modified, or substituted and additional components may be added in certain embodiments.

Voltage source 502 provides an AC drive signal 532 to positive drive 504a and negative drive 504b. First voltage signal 502 acts as a carrier signal and, in some embodiments, may be modulated such that the drive signal is sensed at higher frequencies to more easily detect the signal when 1/f noise is present. Sensing elements 506a, 506b (e.g., including proof mass sense electrodes 206a, 206b) concurrently provide the drive signal 532 to first sensor 508 in accordance with the drive voltage signal 502 received from positive drive 504a and negative drive 504b. The displacement of first sensor 508 relative to sensing elements 506a, 506b (e.g., acting as a moving capacitor) generates a first (e.g., capacitive) signal sensitive to a first frequency range between a first and second frequency (e.g., relatively close to and including DC) that is modulated by drive signal 532. First sensor 508 (e.g., a tilt sensor with differential sensing) operates at a low bandwidth and is stable for DC external excitation (e.g., at low frequency). The first sensor 508 functions at relatively lower frequencies and is relatively more stable at DC external excitations, e.g., in comparison to other sensors such as the second sensor 524. First sensor 508 (e.g., including proof mass 210), in response to the external excitation, outputs the first (e.g., capacitive) signal at the first frequency range to amplifier 510, which converts the first (e.g., capacitive) signal to a first voltage signal at the first frequency range. Feedback capacitor 512 couples to the input and output of amplifier 510. Amplifier 510 delivers the first signal to ADC 514a (e.g., signal processor 536), which converts the received first signal from the analog domain to the digital domain to create a first digital output. ADC 514a delivers the first digital output to combining circuitry 516 at the first frequency range between the first and second frequency. In some embodiments, additional circuitry may process the signal output from the first sensor in the analog or digital domain, for example, to demodulate the drive frequency to shift the signal to DC and/or to perform low pass filtering.

A second power supply provides a second voltage 520 to second sensor 524 (e.g., a single-sided accelerometer functioning as a bone-conduction microphone sensor). The second sensor 524 utilizes sensing that is sensitive to higher frequency external excitations. The external excitation causes the proof mass of the second sensor 524 to move with respect to sensing element 522 as described herein (e.g., resulting in single-sided sensing with stable operation at higher frequencies). The translation (e.g., displacement) of second sensor 524 with respect to sensing element 522 results in capacitive engagement (e.g., creating a moving capacitor), which generates a second (e.g., capacitive) output that is sensitive at a second frequency range between a third and fourth frequency. Second sensor 524 is sensitive at a relatively large bandwidth at higher frequencies, but is more susceptible to exogenous loads like temperature, surface mounting, board bending, and the like (e.g., at low frequency). Second sensor 524 has a constant charge 534 that is maintained via a feedback signal 530 to sensing element 522. The variable feedback signal 530 is maintained and fed back from amplifier 528 to sensing element 522 to facilitate the constant charge across sensing element 522 and second sensor 524, in which case the voltage drop continuously changes (e.g., in response to an output of amplifier 528) so constant charge 534 remains the same. In some embodiments, in response to an input voltage (e.g., second voltage 520) greater than a threshold voltage, second sensor 524 may increase in sensitivity (e.g., lower an effective spring rate of the second sensor 524). In some embodiments, a spring softening is greater than 80% of the mechanical spring stiffness.

A parasitic capacitance may exist at the output of second sensor 524 (or any of the capacitive sensors described herein). Depending upon the effect of the parasitic capacitance on the output signal 534, filter 526, and/or amplifier 528, it may be desirable to boot strap the output of the second sensor to effectively eliminate the parasitic capacitance. Although boot strapping may be performed in a variety of suitable manners as is known in the art, in an exemplary embodiment, electrical connection may be made between a voltage source of the amplifier 528 to a corresponding component at the output of the second sensor 524 that forms the parasitic capacitance (e.g., shielding on a signal line for providing output signal 534).

Second sensor 524 delivers the second (e.g., capacitive) signal 534 to high-pass filter 526, which passes the second signal at the second frequency range if its frequency is above a cutoff frequency, otherwise high-pass filter 526 attenuates the second signal if its frequency is below the cutoff frequency. Although a high-pass filter 526 with a particular design is depicted in FIGS. 5A and 5B, it will be understood that a variety of suitable high-pass and/or band pass filter designs and methods may be utilized in accordance with the present disclosure. High-pass filter 526 includes a low frequency corner (e.g., less than 60 Hz) where second sensor 524 may fail to detect the external excitation accurately, which contributes to second sensor 524 being relatively unresponsive to DC external excitations (e.g., low frequency) in comparison to the first sensor 508. Amplifier 528 modifies its output to retain the input signal corresponding to the charge of the capacitor formed between proof mass 524 and sense electrode 522 constant, and the changing output from amplifier 528 corresponds to the movement of the proof mass of second sensor 524 within the second frequency range between the third and fourth frequency. The output of amplifier 528 feeds back to sensing element 522 (e.g., to deliver variable voltage 530) and couples to ADC 514b (e.g., of processing circuitry 536). The feedback network including amplifier 528, sensing element 522, and second sensor 524 allows amplifier 528 to keep the constant charge of 534, actuated by variable voltage 530, across sensing element 522 and second sensor 524. Amplifier 528 delivers the second voltage signal at the second frequency range to ADC 514b, which converts the received signal from the analog domain to the digital domain to create a second digital output. ADC 514b delivers the second digital output to combining circuitry 516 corresponding to sensed acceleration within the second frequency range between the third and fourth frequency, and the combining circuitry 516 (e.g., adders, multipliers, etc.) having also received the first digital output corresponding to acceleration within the first frequency range between the first and second frequency from ADC 514a, combines the digital signals into a single combined digital signal 518 including frequency content within both first frequency range and the second frequency range.

The dual MEMS integration of first sensor 508 (e.g., including proof mass 210) and second sensor 524 allows system 500 to emphasize the characteristics of the first sensor 508 and second sensor 524 within appropriate frequency ranges within the combined signal 518 to facilitate operation of the system 500 with low noise and high bandwidth throughout relevant frequencies, and with stability at DC voltage. In some embodiments, further processing such as scaling of the amplitudes of the digital signals may be performed such that the outputs are similarly scaled. In some embodiments, additional sensors (e.g., additional accelerometer types/designs all sensing movement along a common axis) may be included, each of which may have a unique (e.g., combined ADC paths) analog and digital processing circuitry for eventual combination at combining circuitry 518. In this manner, a combined output signal can be optimized for any suitable number of frequency ranges.

FIG. 5B shows an illustrative circuit diagram of an additional embodiment of a combined MEMS system in accordance with an embodiment of the present disclosure. FIG. 5B is similar to FIG. 5A, except that electrode 522 is connected to ground and the feedback path 530 is removed. In this embodiment the charge 534 changes in response to the external excitation. The second voltage 520 may be a DC or an AC input voltage, for example, to provide for frequency upshifting of the sensing signal.

Second sensor 524 delivers the second (e.g., capacitive) signal 534 to high-pass filter 526, which passes the second signal at the second frequency range if its frequency is above a cutoff frequency, otherwise high-pass filter 526 attenuates the second signal if its frequency is below the cutoff frequency. High-pass filter 526 includes a low frequency corner (e.g., less than 60 Hz) where second sensor 524 may fail to detect the external excitation accurately, which contributes to second sensor 524 being relatively unresponsive to DC external excitations (e.g., low frequency) in comparison to the first sensor 508. Amplifier 528 changes its output based on the content of capacitive signal 534 within the frequency range of interest, outputting an amplified version of capacitive signal 534 that in turn corresponds to the movement of the proof mass of second sensor 524 within the second frequency range between the third and fourth frequency. The output of amplifier 528 couples to ADC 514b (e.g., of processing circuitry 536), which converts the amplified signal from the analog domain to the digital domain to create a second digital output. ADC 514b delivers the second digital output to combining circuitry 516 corresponding to sensed acceleration within the second frequency range between the third and fourth frequency, and the combining circuitry 516 (e.g., adder, multipliers, etc.), having also received the first digital output corresponding to acceleration within the first frequency range between the first and second frequency from ADC 514a, combines the digital signals into a single combined digital signal 518 including frequency content within both first frequency range and the second frequency range.

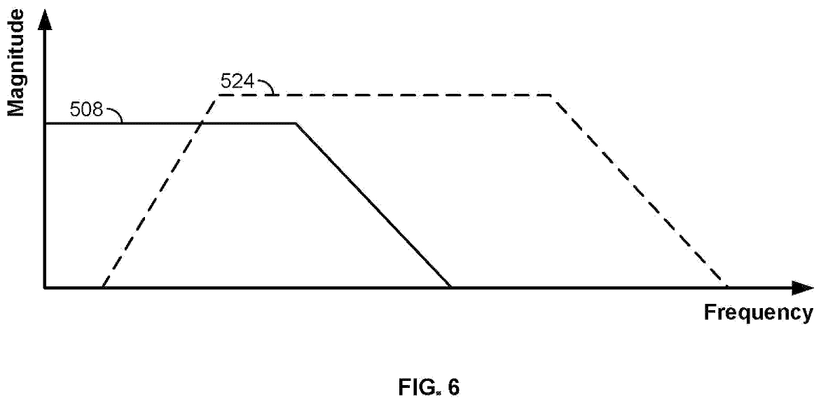

FIG. 6 shows an illustrative diagram depicting respective operational bandwidths of first sensor 508 and second sensor 524 in accordance with an embodiment of the present disclosure. First sensor 508 functions at a low bandwidth and is stable for DC external excitations as described herein. As conveyed by FIG. 6, first sensor 508 has a high sensitivity to low frequency excitations at and close to 0 Hz (e.g., up to 60 Hz, and depicting DC stability) and operates at a low frequency bandwidth. Second sensor 524 has a high sensitivity at a higher frequency range, which in the embodiment depicted in FIG. 6, at least partially overlaps with the sensitivity range of first sensor 508. As conveyed by FIG. 6, second sensor 524 may have relatively low sensitivity and stability at lower frequencies (e.g., below 60 Hz). In ranges where there is a stable, sensitive response for both or multiple sensors, processing circuitry such as the combining circuitry may further combine the overlapping portions in a suitable manner, such as averaging or other suitable statistical methods of combining the signals.

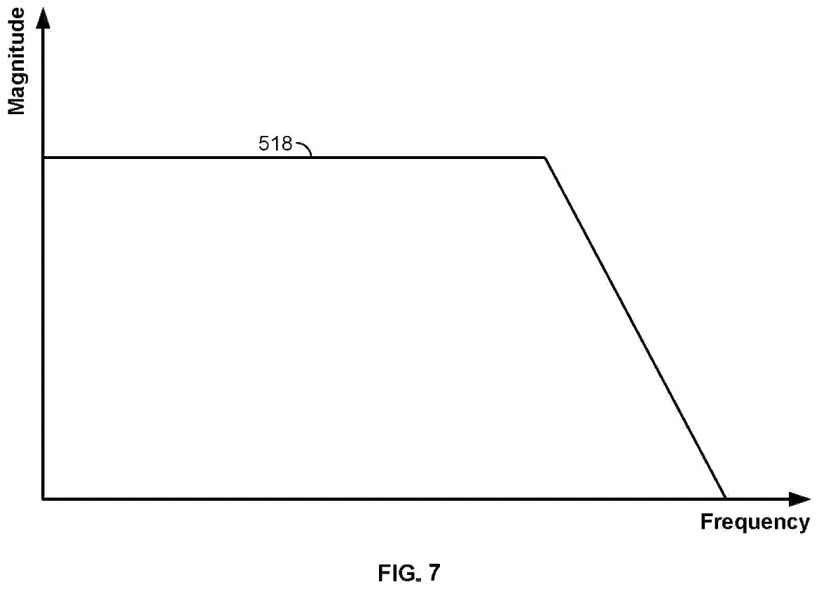

FIG. 7 shows an illustrative diagram depicting an operational bandwidth of a dual MEMS system in accordance with an embodiment of the present disclosure. As depicted in FIG. 7, the combined range (e.g., of combined signal 518) includes the entirety of the ranges of the two sensors 508 and 524 depicted in FIG. 6.

Although two sensors with partially overlapping frequency ranges are depicted in FIGS. 5-7, it will be understood that the sensor designs may be selected for particular desired frequency sensing ranges and applications. For example, a design might not have sensitivity to DC excitations, or the frequency ranges might not overlap. Further, more than two sensors might be utilized for multiple additional frequency ranges.

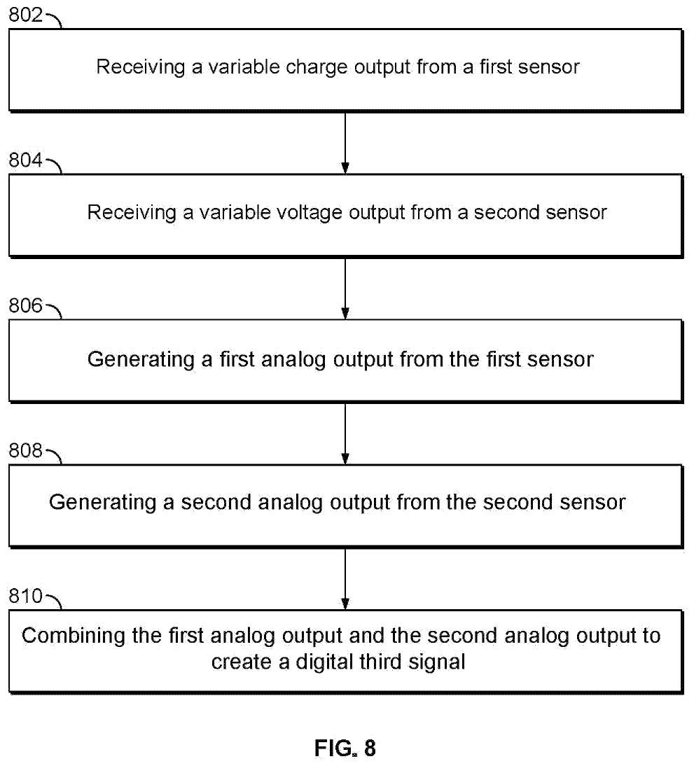

FIG. 8 shows an illustrative flowchart for combining a first signal (e.g., having sensitivity at a low frequency) and a second signal (e.g., having a bandwidth of sensitivity at higher frequencies) into a third signal in accordance with an embodiment of the present disclosure. In at least some example approaches, the first and second signals may be analog signals, with the third signal being a digital signal. Although particular steps are depicted in certain configurations for FIG. 8, steps may be removed, modified, or substituted and additional steps may be added in certain embodiments. In some implementations, more than two signals may be combined, each having sensitivity to different frequencies, by repeating steps depicted and described in FIG. 8.

At step 802, processing circuitry receives a voltage corresponding to a variable charge signal (e.g., first variable charge signal 502) from a first sensor 508, that moves in response to an external excitation. The external excitation causes the displacement of the proof mass, of the first sensor 508, relative the first sensing element (e.g., sensing elements 506a, 506b) generating a first change in the sensing element. The first sensing element (e.g., sensing elements 506a, 506b) generates charge that moves in response to the external excitation that is amplified to provide a voltage representative of the movement of the first sensor. The dynamics of the proof mass of the first sensor limit the frequency conversion of the external excitation and the variable charge signal output.

At step 804, in the context of FIG. 5A, feedback circuitry applies a variable voltage 530 to sensing element 422 to maintain a constant charge (e.g., constant charge 534) to a second sensor (e.g., second sensor 524), where a second sensing element (e.g., sensing element 522) of the second sensor has a variable voltage (e.g., variable voltage 530) to maintain the constant charge despite movements of the second sensor 524, in response to the external excitation, relative to the sensing element 522. The variable voltage output (e.g., variable voltage 530) corresponds to the movement of the second sensor (e.g., second sensor 524) relative to the second sensing element (e.g., sensing element 522). In the context of FIG. 5B, a changing charge output from the second sensor may be amplified to provide a voltage output representative of the motion of the second sensor within the frequency range of interest.

At step 806, processing circuitry generates a first analog output from the first sensor (e.g., first sensor 508) where a variable charge moves in response to an external excitation. As described above, the first sensing element (e.g., sensing elements 506a, 506b) generates charge that moves in response to the external excitation, which is amplified to a voltage output representative of that change in charge. This signal may then be processed, such as by a low-pass filter or other filtering and/or scaling operations, before being provided to an ADC and digital circuitry for further processing.

At step 808, processing circuitry generates a second analog output from the second sensor (e.g., second sensor 524) based upon the variable voltage (e.g., variable voltage 530). As described above, the variable voltage (e.g., variable voltage 530) changes based on the movement of the second sensor relative to the second sensing element 522, with relatively high sensitivity within the second frequency range (e.g., between the third and fourth frequency). This signal may then be processed, such as by additional filtering and/or scaling operations, before being provided to an ADC and digital circuitry for further processing.

At step 810, processing circuitry 536 combines the first analog output (of the first sensor 508) and the second analog output (of the second sensor 524) to create a combined digital output signal (e.g., third signal 518). The processing circuitry 536 receives the first analog output sensitive within first frequency range (e.g., between the first and second frequency) and the second analog output sensitive within the second frequency range (e.g., between the third and fourth frequency) such as at ADCs 514a, 514b. ADC 514a converts the received first analog output from the analog domain to the digital domain to produce a first digital output, and ADC 514b converts the received second analog output from the analog domain to the digital domain to produce a second digital output. ADC 514a delivers the first digital output to combining circuitry 516 and ADC 514b delivers the second digital output to combining circuitry 516. Combining circuitry 516 combines the signals to generate a signal that is sensitive within both the first frequency range and the second frequency range.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A microelectromechanical system (MEMS) device, comprising:
a first sensor configured to output a first signal;
a second sensor configured to output a second signal, wherein the first and the second sensors are configured to receive an external excitation to generate the first and the second signals, respectively; and
processing circuitry that receives a signal based on the first signal and a signal based on the second signal and outputs a third signal in response to the external excitation, wherein the third signal includes the first signal within a first frequency range between a first frequency and a second frequency, and wherein the third signal includes the second signal in a second frequency range between a third frequency and a fourth frequency, wherein the first frequency is less than the second, the third, and the fourth frequencies, and wherein the fourth frequency is greater than the first, the second, and the third frequencies.

2. The MEMS device of claim 1, wherein the first signal is output based upon a variation of a charge associated with the first sensor.

3. The MEMS device of claim 2, wherein the variation of the charge is based on a movement of the first sensor, and wherein a voltage source signal is provided to the first sensor.

4. The MEMS device of claim 3, wherein the voltage source signal is AC and is configured to AC modulate the first signal.

5. The MEMS device of claim 1, wherein the second signal is output based upon a variation of a voltage associated with the second sensor.

6. The MEMS device of claim 5, wherein the variation of the voltage is based on a movement of the second sensor, and wherein a DC voltage source signal is provided to the second sensor.

7. The MEMS device of claim 6, wherein the second sensor has constant charge.

8. The MEMS device of claim 1, further comprising a buffer coupled to the output of the second sensor boot strap the second sensor.

9. The MEMS device of claim 1, wherein further comprising a first amplifier coupled to the output of the first sensor and a second amplifier coupled to the output of the second sensor, and wherein a first input to the first amplifier and a second input to the second amplifier are both low impedance inputs.

10. The MEMS device of claim 1, wherein the second sensor further comprises a proof mass that translates in response to the external excitation.

11. The MEMS device of claim 10, wherein the second sensor further comprises a proof mass that rotates in response to the external excitation.

12. The MEMS device of claim 1, wherein the third frequency and the fourth frequency define an audio frequency range.

13. The MEMS device of claim 12, wherein the audio frequency range is below 20 kHz.

14. The MEMS device of claim 13, wherein the audio frequency range is below 3.5 kHz.

15. The MEMS device of claim 1, further comprising a high-pass filter with a low frequency corner coupled between the second sensor and an amplifier.

16. The MEMS device of claim 15, wherein the low frequency corner is less than 60 Hz.

17. The MEMS device of claim 15, wherein an output of the amplifier feeds back to the second sensor.

18. The MEMS device of claim 17, wherein the second sensor is configured to maintain a constant charge based upon a variable voltage provided from the amplifier to the second sensor, and wherein the variable voltage corresponds to the signal based on the second signal.

19. The MEMS device of claim 1, wherein the second sensor is configured to increase a sensitivity of the second sensor in response to a bias voltage, and wherein the increase in the sensitivity of the second sensor lowers an effective spring rate of the second sensor.

20. The MEMS device of claim 1, wherein the processing circuitry comprises a first analog-to-digital converter (ADC), a second analog-to-digital converter (ADC), and a combining circuitry, and wherein the third signal is digital.

21. The MEMS device of claim 1, wherein the first sensor and the second sensor each comprise an accelerometer.

22. The MEMS device of claim 1, wherein the first sensor and the second sensor each include a common sensor type of a barometer, a microphone, a magnetometer, or a gyroscope.

23. A microelectromechanical system (MEMS) device, comprising:
a first sensor configured to output a first signal based upon a movement of a first proof mass of the first sensor relative to a first sensing element having a first voltage and a variable first charge;
a second sensor configured to output a second signal based upon a movement of a second proof mass the second sensor relative to a second sensing element, wherein the second signal is based upon a variable voltage signal provided to the second sensing element, and wherein the first and the second sensors are configured to receive an external excitation to generate the first and the second signals, respectively; and
processing circuitry configured to receive the first signal and the variable voltage signal, wherein the processing circuitry is configured to generate a third signal, wherein the third signal includes a portion of the first signal between a first frequency and a second frequency, and wherein the third signal includes a portion of the variable voltage signal between a third frequency and a fourth frequency.

24. A method, comprising:
receiving an external excitation at a MEMS device comprising a first sensor and a second sensor, wherein the first sensor is configured to output a first signal in response to the external excitation, and wherein the second sensor is configured to output a second signal in response to the external excitation; and
generating a third signal from a signal based on the first signal and a signal based on the second signal, wherein the third signal includes the first signal when the external excitation is between a first frequency and a second frequency, and wherein the third signal includes the second signal when the external excitation is between a third frequency and a fourth frequency.
